(19) United States
(12) Patent Application Publication
(10) Pub. No.: US 2002/0012772 A1
(43) Pub. Date: Jan. 31, 2002

(54) Furniture edge cover

(76) Inventor: Richard Graham Kraemer, Clifton (GB)

Correspondence Address: JACOBSON, PRICE, HOLMAN & STERN, PROFESSIONAL LIMITED LIABILITY COMPANY, THE JENIFER BUILDING, 400 SEVENTH STREET, N.W., WASHINGTON, DC, 20004, US

(21) Appl. No.: 09/770,637

(22) Filed: Jan. 29, 2001

(30) Foreign Application Priority Data
Jul. 29, 2000 (GB) 0018638.7

(51) Int. Cl. B32B 3/20

(52) U.S. Cl. 428/188

(57) ABSTRACT

An edge cover is described for fitment to a furniture edge in the form of an elongate flexible cushioning member having two laterally extending faces at an angle to each other for fitment over the edge, at least one of the laterally extending faces comprising a double-wall structure of plastics material defining a gap which serves to cushion any impact thereon. The invention is also a kit of parts and a method for the fitment of such a device to a furniture edge, particularly as an after-market modification.

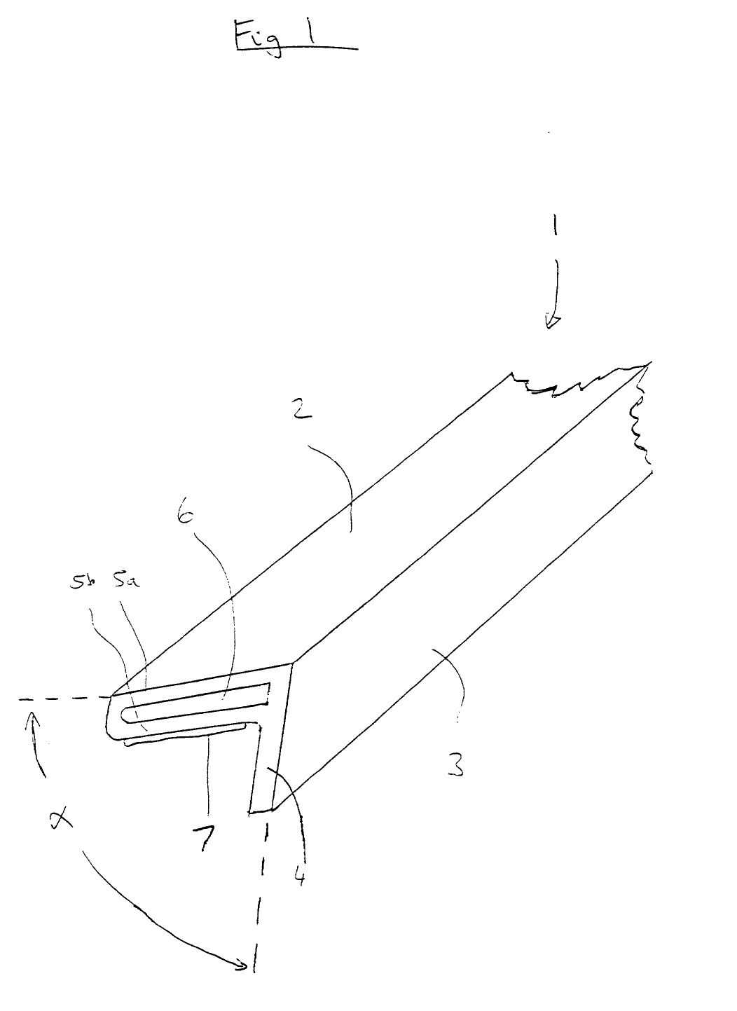

The invention relates to an edge cover for fitment to an exposed edge of an item of furniture, such as a table or desk, shelving, cupboard or cabinet, door or door frame, window or window frame or the like. The invention is designed for fitment to an exposed edge for the dual purpose of protecting the furniture itself from damage, and providing a degree of cushioning to minimise injury in the event of impact by a human user of the furniture.

The sharpness of exposed edges and comers of furniture presents an increasing problem in relation to modem furniture design and materials, particularly where furniture is of modular structure using, for example, composite panels, having a composite core of material such as medium density fiber board panels, for the body, covered with a thin rigid plastic finishing coat, and/or using steel frame elements, or the like.

In the case of traditional furniture, manufactured from solid wood or thick wood veneer, it was a relatively simple matter to finish the wood so as to limit the sharpness of the angularity of edges and comers. This is not such a straightforward matter with modem materials, such as of the type which comprise a composite core (for example of medium density fiberboard or MDF, chipboard, blockboard or plywood etc) with a covering of plastics material. In these instances, three approaches can be identified. According to the first approach, a relatively flexible coating material, for example, in the form of a vinyl coating, is applied over a base with molded rounded edges. According to the second approach, additionally or alternatively, moldings of a rigid plastic materials or the like having generally more rounded edges are fitted to the sides of the panel. This allows use of a thinner, harder plastics material, for example to provide a wood grain effect, for the body of the desk top to be applied over the composite core.

However, both of these constructions are complex, and the third approach, more commonly followed for much mass produced and in particular modular furniture, is merely to apply a thin rigid plastic veneer on all the exposed surfaces of an MDF or similar core. This option is cheaper and simpler to fabricate, but produces relatively sharp angles at the edges. As a consequence, a user colliding with an edge may experience greater discomfort and/or risk of injury, and the edge is prone to damage, in particular to the veneer material.

Additionally, there is sometimes a desire to provide cushioning protection to furniture edges. Of course, whilst the problem is especially significant with the sharp comers encountered in some modem materials, it is not restricted to them, and circumstances arise where covering of conventional wooden edges, metal frame edges or the like is desirable. In particular for example, such protection might be provided in association with protruding furniture edges, door frames and the like. The need is likely to arise especially where the location/visibility is such that the risk of collision is high or where infants are present. The application of inherently cushioning materials, such as open cell foams, is known for this purpose.

Cushioning may also be of value for example in relation to office desks and tables, to cushion forearms when writing or using computer keyboards etc. This may help alleviate problems associated with repetitive strain injury in the office.

Additionally, there is often a desire to provide markings to furniture edges so that they stand out visibly, for example to mark dangerously protruding edges, to mark door frames to identify exit routes etc. This has been done, for example, by application of brightly colored adhesive tape or the like.

It is an object of the present invention to provide an edge covering for furniture which provides a degree of protection and cushioning to the furniture mitigation some or all of the problems in the prior art.

It is a particular object of the present invention to provide an edge covering for furniture which is readily fabricated and easily fitted to an edge, in particular through not exclusively a sharply angular furniture edge, such as of the type encountered in modem modular furniture, comprising a composite core of MDF or similar material with a rigid plastics veneer covering.

It is a further object of the present invention to provide an edge covering for furniture which, in addition to cushioning and protecting a furniture edge, is also readily adaptable to provide an integral edge identifying function, for example for safety reasons.

Thus, according to a first aspect of the present invention, an edge cover for fitment to a furniture edge comprises an elongate flexible member comprising a first elongate face and at least one further elongate face extending laterally alongside thereof and at an angle thereto, wherein at least one of the elongate faces comprises a double-wall structure of plastics material, the walls defining a laterally extending gap therebetween.

The invention is of inherently very straightforward construction, but nevertheless, when fitted on a furniture edge, confers both protection and a degree of cushioning. This latter function is provided primarily by the double walled structure and gap defined between. Unlike the relatively rigid and solid plastic materials conventionally used for edging exposed sides of MDF-based or similar furniture, the plastic material of the present invention is flexible and this feature in conjunction with the gap defined by the double-walled structure provides a degree of cushioning.

Any plastics material which offers sufficient flexibility, and preferably a degree of flexible resilience, is suitable for the present invention. Material selection considerations are therefore likely to be primarily those relating to ease of fabrication, cost and the like. With these in mind in particular, the plastics material is preferably a thermoplastic material, and especially preferably an extrudable thermoplastic material. Suitable material would include plasticized vinyl polymers such as PVC, rubberised polyesters and the like. PVC is particularly preferred by being readily available, readily extrudable, and offering adequate flexibility and resilience.

Reference herein to furniture is to room furniture such as tables, desks and the like, shelving, cupboards etc and to a door and window furniture such as doors and door frames, windows and window frames and sills etc.

Reference herein to a furniture edge is to any elongate edge extending between two faces of a furniture panel. In particular, the invention is applicable to the markedly angular edges associated with furniture panels, and in particular modular panels, which have been manufactured from a composite core such as MDF with a thin plastic veneer coating. It will be appreciated that an edge cover in accordance with the invention may be configured to protect more than one edge, for example being untied at the corners to fit all four faces of a rectangular panel.

Preferably, a single material is used for the material of the elongate walls, preferably as a single extrusion. The gap defined by the walls may be filled with a suitable impact attenuating material, such as a resilient plastics or rubber material, open cell foam, gel or the like and/or may be of any suitable shape to afford some cushioning, such as a cellular or honeycomb structure, extending along all or part of the length of the walls. However, for simplicity of manufacture, the gap is preferably open and extends substantially along the entire length. This is still found to give adequate cushioning for most purposes, and significantly simplifies the fabrication procedure.

Preferably, the external edge presented by the edge cover (at the point where two adjacent walls meet) is rounded rather than sharply angular. This affords additional protection, and is likely to be easier to achieve with the preferred extruded materials.

The furniture edge cover may be attached to the furniture by any suitable means, and in a further aspect of the invention there is provided a modular furniture panel and/or a kit of parts for assembly of a modular item of furniture and/or an assembled item of furniture to which edging in accordance with the present invention is fitted. Alternatively, the edge cover is supplied for after market fitment to an item of furniture.

The edge cover may suitably be attached to the furniture by any suitable permanent or temporary/releasable attachment, in particular by permanent bonding such as gluing, by use of mechanical attachments such as snap fit connectors, by use of adhesive tape, by use of mutually co-operable fabric loop and resilient hook pads attached to facing surfaces, or by any other suitable permanent or releasable connection.

In a particularly preferred embodiment, in particular where the invention is supplied for after market fitment to an item of furniture, at least one face of the edge cover is providing on an inner surface thereof with adhesive portions, for example in the form of attached adhesive tape, extending along at least part of the length. Preferably, adhesive tape extends along substantively all of the length of at least one of the walls, and preferably all of the walls. The adhesive tape is preferably provided with a non-adhesive backing layer which protects the adhesive surface during storage and shipment and is removable to expose the adhesive surface for fitment of the edge cover. Alternatively, adhesive tape may be supplied separately with the edge cover.

To enhance the consistency of the fixing to the furniture edge, the edge cover may exploit the resilience of the plastics material, in that it is fabricated such that an internal angle between two faces is less than the angle between the two faces of the edge to which it is to be fitted. In most instances, this latter will be 90°, in which case the internal angle between the two faces of the furniture edge cover to be fitted thereover is, for example, 60-80°. The plastics material is then slightly distorted on fitment over the edge, and the resilience of the plastics material causes the edge cover to grip the edge of the furniture more intimately.

In its simplest and most versatile embodiment, the edge cover comprises two elongate faces, one of both or which has the double-walled structure. For example, for fitment on a right angled edge, the edging has a generally L-shaped structure in transverse cross-section. For certain specific applications, edging with more than two faces might be envisaged (having, for example, three elongate faces of generally U-shaped transverse cross-section).

The edge cover may be fabricated in any suitable manner. For example, the edge cover may be fabricated as a continuous single extrusion and cut to length. Alternatively, the edge cover may be fabricated from sheet material which is then folded, bonded and shaped appropriately. Alternatively an elongate extrusion of the at least two faces having single solid walls has a second wall attached subsequently, by gluing, thermal bonding or other suitable technique. In a preferred embodiment, for simplicity of manufacture the edge cover is a one-piece extrusion of extruded thermoplastic material.

In a further aspect of the invention, there is provided the use of an edge cover as hereinbefore described to protect and cushion a furniture edge.

It is a particular advantage of the materials envisaged for use in the present invention that they can generally be readily colored. In some instances, it will be desirable for the color to co-ordinate with that of the furniture to be edged. However, in other instances, a contrasting color might be desirable, for example as a safety measure to ensure ready identification of dangerously protruding edge or for other purposes. In particular for this purpose, fluorescent colors may be used. Thus, a preferred embodiment of this aspect of the invention comprises the use of the edge cover, by provision of suitable coloration, as an identification device to identify an edge.

In a further aspect of the invention there is provided a kit of parts for the after market fitment of an edge cover in accordance with the present invention to a piece of furniture, said kit of parts comprising at least one edge cover in accordance with the present invention and suitable means to fix the edge cover onto a piece of furniture. Preferably, the fixing means are in the form of adhesive tape, either as adhesively double-sided tape, or as tape already attached to at least one inner face of the edge cover and adhesive on the unattached surface. The or each adhesive surface is preferably protected by a removable non-adhesive backing layer.

The invention will now be described by way of example only with reference to the accompanying drawings, illustrating part of an edging in accordance with an embodiment of the invention.

Referring to the FIGURE, a single piece elongate extrusion of plasticized PVC (1) is shown.

The extrusion has two faces (2, 3) disposed relatively to each other in generally L-shaped form at an angle α. The extrusion is designed for fitment on a right angled edge on a piece of furniture the angle α therefore being less than 90° to assist in fitment of the extrusion (1).

The face (3) comprises a solid wall structure (4), but the face (2) has a double-wall structure (5a, 5b) defining an air gap (6) therebetween. This provides a degree of cushioning. A layer of self adhesive tape (7) is provided on an inner surface of the wall (5b) to facilitate fitment of the device onto a furniture edge. In other circumstances, it might be desirable to provide a similar layer additionally or alternatively on the inner surface of the wall (4), and/or to supply adhesive tape separately for in-situ fixing of the edge cover.

This particular embodiment is specifically adapted for fitment along the front edge of a desktop or the like. The edging is fitted by removal of the backing layer which will typically be provided with the self-adhesive tape (7) and by attachment of the wall (4) using the self-adhesive tape (7) to the forward portion of the upper desk surface. The face (2) with double walls (5a, 5b) thus extends over the upper forward edge of the desk and protects and cushions the forward face thereof.

The extrusion (1) may be provided in a color to co-ordinate with the desktop, or may be provided in a brightly contrasting color, either for safety reasons or for aesthetic reasons.

Other suitable configurations of edging will be readily understood to be appropriate for application to other circumstances.

1. An edge cover for fitment to a furniture edge comprises an elongate flexible member comprising a first elongate face and at least one further elongate face extending laterally alongside thereof and at an angle thereto, wherein at least one of the elongate faces comprises a double-wall structure of plastics material, the walls defining a laterally extending gap therebetween.

2. An edge cover as claimed in claim 1 wherein the plastics material is flexibly resilient.

3. An edge cover as claimed in claim 1 wherein the plastics material is a thermopastic material.

4. An edge cover as claimed in claim 3 wherein the plastics material is an extrudable thermoplastic material.

5. An edge cover as claimed in claim 4 wherein the plastics material is selected from the group comprising PVC and rubberised polyesters.

6. An edge cover as claimed in claim 1 wherein the material of the elongate faces comprises a single extrusion.

7. An edge cover as claimed in claim 1 wherein the said laterally extending gap is filled with an impact attenuating material.

8. An edge cover as claimed in claim 7 wherein the impact attenuating material is selected from the group comprising resilient plastics or rubber material, open cell foam or gel.

9. A furniture edge cover as claimed in claim 1 wherein at least one face of the edge cover is provided on an inner surface thereof with adhesive portions in the form of attached adhesive tape extending along at least part of the length.

10. An edge cover as claimed in claim 1 wherein the internal angle between the two faces is of the order of 60 to 80 degrees.

11. A kit of parts for the after market fitment of an edge cover in accordance with claim 1 to a piece of furniture, said kit of parts comprising at least one edge cover as claimed in claim 1 and suitable means to fix the edge cover onto a piece of furniture.

12. A kit of parts as claimed in claim 11 wherein the fixing means are in the form of adhesive tape.

13. A method for the protection of a furniture edge comprising the after-market fitment of an edge cover in accordance with claim 1 to said edge.
